(19) United States
(12) Patent Application Publication
(10) Pub. No.: US 2004/0221316 A1
(43) Pub. Date: Nov. 4, 2004

(54) Addressable tap capable of detecting numbers of TV sets online to watch CATV porgrams

(76) Inventors: Yung-Liang Chang, KaoHsiung City (TW); Chih-chou Shih, Taichung City (TW)

Correspondence Address: Judson K. Champlin, Westman, Champlin & Kelly, Suite 1600, 900 Second Avenue South, Minneaplois, MN, 55402-3319, US

(21) Appl. No.: 10/827,147

(22) Filed: Apr. 19, 2004

(30) Foreign Application Priority Data
Apr. 29, 2003 (CN) 03225804.6

(51) Int. Cl. H04N 7/16; H04N 7/173

(52) U.S. Cl. 725/127; 725/106; 725/107; 725/149; 725/120

(57) ABSTRACT

An addressable tap capable of detecting number of TV sets online to watch CATV programs consisting of a main block and a cable connecting from the terminal of said main block and the user. Said main block consists of a main central processing unit (CPU) and RF switches that are electrically connected is featured by: Said cable is equipped with a locking device at its user end and this locking device consists of a detection device and a sub-CPU that communicates with said main CPU; said detection device is electrically connected to the sub-CPU; In case said locking device is plugged out, the detection device will detect the information and transmit it to said microprocessor, which will send the information to said main CPU. Said main CPU will instruct the RF switches to shut off CATV signals at the terminal. the present invention has the following effects: CATV operators can collect different fees in accordance with number of TV sets online to watch TV programs and avoid income losses of CATV operators.

### FIELD OF INVENTION

This invention is involved to the image communication technological sector, especially an addressable tap used in CATV that can be managed in payment collection.

### BACKGROUND OF THE INVENTION

In the existing technology, after a cable is connected from one terminal of the addressable tap to the user, there is no any measure to limit the number of TV sets online to watch TV programs in the user. No matter how many TV sets are in the user's home, the payment for CATV is the same. As payment of subscribers tap user is fixed, in case that TV sets are increased inside the user, the CATV operators will run income losses.

### BRIEF SUMMARY OF THE INVENTION

Technical problems that the current invention aims to solve is avoiding the disadvantages in the existing technology by way of a new addressable tap, which can limit TV sets online in each subscribers family to watch CATV programs. In this way, CATV operators can collect different fees according to number of TV sets online to watch CATV programs.

The technical problems that this invention aims at can be solved by the following technical plan:

Design and use an addressable tap capable of detecting number of TV sets online to watch CATV programs that consists of a main block and a cable connecting the terminal of the main block of tap and the user. Said main block consists of a main central processing unit (CPU) and RF switches that are electrically connected. The user end of said cable is equipped with a locking device that consists of a detecting device and a sub-CPU that can communicate with the main CPU; said detecting device is electrically connected with the sub-CPU; in case that said locking device is plugged out, the detection device will detect the information and transmit it to said microprocessor, which will transmit the information to said main CPU in turn and the main CPU will instruct the RF switches to shut off CATV signals at the terminal.

Compared with the existing technology, the present invention has the following effects: CATV operators can collect different fees in accordance with number of TV sets online to watch TV programs and it is easy in management to avoid income losses of CATV operators.

### BRIEF DESCRIPTION OF THE DRAWINGS

FIG. 1 is a sketch of working principles of the current invention addressable tap.

FIG. 2 is an electric sketch diagram of the addressable tap main block.

FIG. 3 is a sketch of the cable of the addressable tap.

### PREFERRED EMBODIMENT

Further introduction is made in combination with the attached drawings.

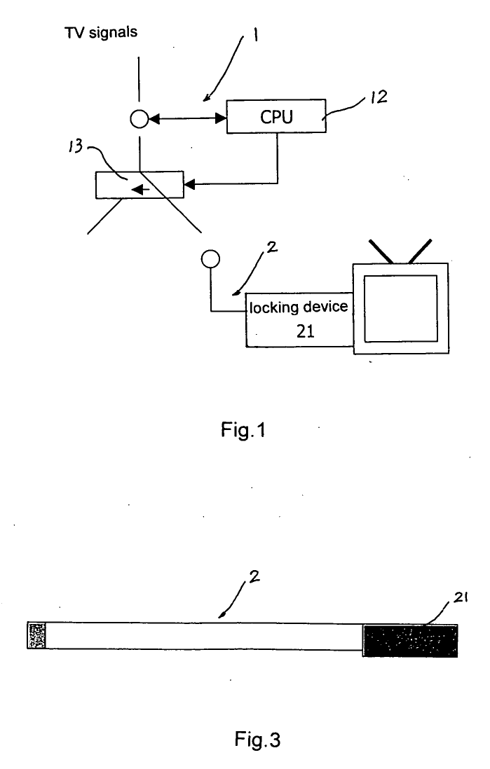

An addressable tap capable of detecting number of TV sets online to watch CATV programs as shown in FIG. 1 and 3 consists of a main block 1 and a cable 2 connecting from terminal 11 of said main block 1 to the user. Said main block 1 consists of a main central processing unit namely CPU12 and RF switches 13. Said cable 2 is equipped with a locking device 21 at its user end and this locking device 21 consists of a detecting device and a sub-CPU that can communicate with said main CPU; said detecting device and sub-CPU are electrically connected; in case that said locking device 21 is plugged out, said detecting device will detect the information and then transmit it to said microprocessor, which in turn transmit the information to said main CPU12. Said main CPU12 will issue instruction to the RF switches 13 to cut off CATV signals at the terminal 11. Said detecting device can be realized by many designs by existing technologies, such as oscillator.

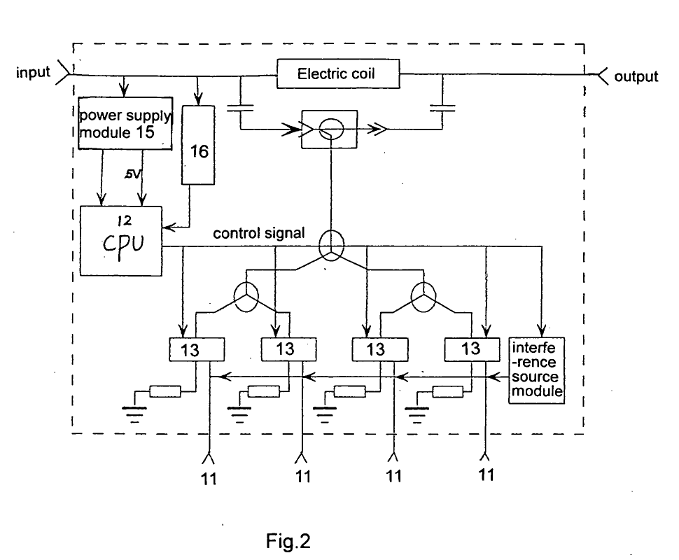

As shown in FIG. 2, said main block 1 also includes a power supply module 15 and a filter and demodulation module 16. Said power supply module 2 and filter and demodulation module 3 are connected to said main CPU12 separately. AC voltage of 60V-90V, control signal at 110 MHz and CATV signals are input at the input terminal. Said power supply module will convert AC voltage of 60V-90V to DC voltage of 5V for power supply to said control module 4. At the same time, the filter and demodulation module 3 will demodulate the control signals inside the input signals and transmit them to the control module 4, which can control the RF switches 5 or control the signal source after receiving the control signals from the filter and demodulation module 3. CATV signals and control signals inside the input are transmitted to the RF switches 5 through capacitors.

As shown in FIG. 3, said cable 2 is compatible with the traditional ones except for there is a locking device 21 equipped to the TV set end. Dimensions of the housing of said main block 1 are within plus minus 30% of standard housings of the existing non-addressable taps. As the shape and size of said housing 1 are the same or compatible with the existing non-addressable taps used in CATV network, the faceplates of traditional taps installed can be replaced easily to realize enhancement of the function to detecting number of TV sets online to watch CATV programs without the need to change the circuits or separate wire laying.

1. An addressable tap capable of detecting number of TV sets online to watch CATV programs consisting of a main block and a cable connecting from the terminal of said main block and the user. Said main block consists of a main central processing unit (CPU) and RF switches that are electrically connected is featured by:
Said cable is equipped with a locking device at its user end and this locking device consists of a detection device and a sub-CPU that communicates with said main CPU; said detection device is electrically connected to the sub-CPU;
In case said locking device is plugged out, the detection device will detect the information and transmit it to said microprocessor, which will send the information to said main CPU. Said main CPU will instruct the RF switches to shut off CATV signals at the terminal.

2. An addressable tap capable of detecting number of TV sets online to watch CATV programs as defined in claim 1 is featured by:
Said main block also includes a power supply module and a filter and demodulator module. Said power supply module and filter and demodulation module are electrically connected to said main CPU.

3. An addressable tap capable of detecting number of TV sets online to watch CATV programs as defined in claim 1 is featured by:
The housing dimensions of said main block is within plus minus 30% of the standard housings of existing traditional non-addressable taps to make it possible to easily replace faceplates of existing traditional taps installed for enhancement.
